(19) United States
(12) Patent Application Publication
(10) Pub. No.: US 2026/0320134 A1
(43) Pub. Date: Oct. 15, 2026

(54) DOCUMENT COLLECTIONS

(71) Applicant: CS Disco, Inc., Austin, TX (US)

(72) Inventor: Pierre PADOVANI, Lago Vista, TX (US)

(21) Appl. No.: 19/648,262

(22) Filed: Apr. 15, 2026

Related U.S. Application Data
(60) Provisional application No. 63/789,068, filed on Apr. 15, 2025.

(51) Int. Cl. G06F 16/93; G06F 16/901; G06F 16/955

(52) U.S. Cl. CPC G06F 16/93; G06F 16/901; G06F 16/9566

(57) ABSTRACT

Systems and methods for managing document collections are provided. Various embodiments of the present technology provide systems and methods for asynchronously updating document groupings within a search index by decoupling collection metadata from individual documents. Embodiments include a system and method that uses a plurality of distinct collection objects that point to corresponding discovery documents in a unidirectional relationship. Upon receiving a request to update a target collection, a difference is computed between a new list of member document identifiers and an existing list to determine a minimal set of collection objects to insert and delete. A bulk index operation is then asynchronously executed to apply this minimal set to the search index without locking or rewriting the underlying discovery documents. This architecture decouples the collection lifecycle from the documents and efficiently supports complex hierarchical set operations.

### CROSS-REFERENCE TO RELATED APPLICATIONS

This application claims the benefit of priority under 35 U.S.C. § 119(e) from U.S. Provisional Application No. 63/789,068, filed Apr. 15, 2025, entitled "DOCUMENT COLLECTIONS," which is fully incorporated by reference herein for all purposes.

### TECHNICAL FIELD

This disclosure relates generally to document organization and management. More particularly, this disclosure relates to systems and methods for grouping large volumes of electronic documents into collections that provide enhanced search and organizational capabilities. Even more specifically, this disclosure relates to a new architecture for managing document collections within a search index that decouples collection metadata from individual documents to enable asynchronous updates, improve performance and support complex hierarchical relationships.

### BACKGROUND

In the field of digital document management, the ability to group and organize large sets of documents is important for various applications such as legal discovery (eDiscovery), workflow management, and information retrieval. Traditionally, techniques for grouping documents have included embedding metadata directly within each document to indicate group membership or utilizing structures like directories and folders. However, these approaches present significant challenges, particularly when dealing with the scale of modern document repositories. Furthermore, conventional attempts to perform both traditional text searches and complex analytical slicing-and-dicing on massive document collections typically require a "polyglot" architecture. Polyglot computing systems utilize two or more distinct database engines, such as one engine optimized for standard search and a separate engine optimized for analytical set operations. Operating multiple discrete database engines forces the computing system to constantly synchronize massive datasets between them, which frequently results in severe computational bottlenecks and notoriously unperformant computing systems.

One problem with embedding group information in document metadata is the performance impact of updating group memberships. When a document needs to be added to or removed from a group, especially a large group containing numerous sizeable documents, the system must lock and rewrite the metadata for every single document in the group. In search indexes, this conventional pattern of deleting and re-adding records incurs significant side effects, including creating windows where documents temporarily lose their group associations, and forcing the database to process significant tombstones and segment merges. This bottleneck is computationally expensive and time-consuming, significantly hindering the overall throughput of document modification and indexing, and severely disrupting the normal search experience for users actively querying the database during these massive update operations.

Furthermore, conventional attempts to perform complex analytical slicing and dicing of document collections, such as executing Venn diagram-style hierarchical queries, often rely on 'polyglot' architectures. These polyglot systems attempt to operate two separate database engines concurrently and struggle to maintain synchronization between them, resulting in notoriously unperforming systems that cannot execute complex hierarchical analysis efficiently within a single search engine.

Therefore, there is a need for an improved solution for creating and managing document collections that can overcome the performance bottlenecks and scalability limitations of existing techniques. Such a solution should enable the rapid creation and modification of arbitrary document groupings without impacting the performance of core document processing, while also providing efficient search capabilities within these collections and the flexibility to represent complex, hierarchical relationships between them.

### SUMMARY

Methods are described that manage document collections within a computing system. The methods maintain a search index storing a plurality of discovery documents and receive a request to update a target document collection with a new list of member document identifiers. A plurality of distinct collection objects corresponding to the new list are generated, where each distinct collection object points to its corresponding discovery document in a unidirectional relationship. A difference is then computed between the new list of member document identifiers and an existing list of member document identifiers in the search index to determine a minimal set of collection objects to insert and a minimal set of collection objects to delete. Finally, the methods asynchronously execute a bulk index operation to apply the minimal set of collection objects to insert and the minimal set of collection objects to delete to the search index without locking or rewriting the plurality of discovery documents, thereby decoupling the lifecycle of the document collection from the lifecycle of the discovery documents.

In some embodiments, systems are described that manage document collections. The systems utilize one or more processors and a memory storing instructions that, when executed, cause the system to maintain a search index storing a plurality of discovery documents and receive a request to update a target document collection with a new list of member document identifiers. The systems generate a plurality of distinct collection objects corresponding to the new list, where each distinct collection object points to its corresponding discovery document in a unidirectional relationship. The systems compute a difference between the new list of member document identifiers and an existing list of member document identifiers in the search index to determine a minimal set of collection objects to insert and a minimal set of collection objects to delete. The systems then asynchronously execute a bulk index operation to apply the minimal set of collection objects to insert and the minimal set of collection objects to delete to the search index without locking or rewriting the plurality of discovery documents, thereby decoupling the lifecycle of the document collection from the lifecycle of the discovery documents.

In some embodiments, non-transitory computer-readable storage media are described that store instructions for managing document collections. The instructions are executable by one or more processors of a computing system to cause the computing system to maintain a search index storing a plurality of discovery documents and receive a request to update a target document collection with a new list of member document identifiers. The computing system generates a plurality of distinct collection objects corresponding to the new list, where each distinct collection object points to its corresponding discovery document in a unidirectional relationship. A difference is computed by the computing system between the new list of member document identifiers and an existing list of member document identifiers in the search index to determine a minimal set of collection objects to insert and a minimal set of collection objects to delete. Furthermore, the computing system asynchronously executes a bulk index operation to apply the minimal set of collection objects to insert and the minimal set of collection objects to delete to the search index without locking or rewriting the plurality of discovery documents, thereby decoupling the lifecycle of the document collection from the lifecycle of the discovery documents.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram of a computing environment architecture for managing document collections.

FIG. 2 is a block diagram illustrating a decoupled domain model for organizing discovery documents and their collection memberships within a search index.

FIGS. 3 and 4 are sequence diagrams illustrating asynchronous background processes for creating and updating document collections, respectively.

FIG. 5 is a conceptual diagram illustrating the execution of hierarchical analysis and logical set operations across document collections within a search index.

FIG. 6 is a flowchart illustrating a method for managing document collections within a computing system.

### DETAILED DESCRIPTION

The disclosure and various features and advantageous details thereof are explained more fully with reference to the exemplary, and therefore non-limiting, embodiments illustrated in the accompanying drawings and detailed in the following description. It should be understood, however, that the detailed description and specific examples, while indicating the preferred embodiments, are given by way of illustration only and not by way of limitation. Various substitutions, modifications, additions and/or rearrangements within the spirit and/or scope of the underlying inventive concept will become apparent to those skilled in the art from this disclosure.

The described embodiments may be better understood with reference to commonly-owned U.S. Patent No. 11,573,996, entitled "System and Method for Hierarchically Organizing Documents Based on Document Portions," filed on Aug. 24, 2021, and U.S. Patent Application Publication No. US 2024/0354318 A1, entitled "System and Method for Searching Tree Based Organizational Hierarchies, Including Topic Hierarchies, and Generating and Presenting Search Interfaces for Same," filed on Apr. 18, 2023, which are incorporated herein by reference in their entireties for all purposes.

The present disclosure relates to an improved architecture for managing document collections within a search index that solves these performance bottlenecks by decoupling the collection metadata from the individual discovery documents. Broadly, the invention separates the data that defines a collection from the underlying document itself, meaning the system no longer has to touch, lock, or rewrite massive parent documents whenever a collection changes. Instead, the system extracts collection membership into its own distinct, lightweight child objects within the search index, which simply point to their corresponding parent documents via a parent-child relationship.

By treating the collection's lifecycle as entirely separate from the document's lifecycle, the system can execute massive grouping updates asynchronously in the background. This loosely coupled design significantly improves system performance and ensures that active user search experiences remain entirely undisrupted during massive data updates. Furthermore, this decoupled architecture natively supports the creation of complex, hierarchical collection structures (such as superset collections), enabling highly performant, Venn diagram-style set operations directly within the search engine.

Beyond legal workflow stages and search term reports, this decoupled architecture ensures broad applicability across various other use cases. For example, the system can be used for creating "frozen search results". This allows users to preserve the exact state of a search result to easily allow for comparison with new or updated documents at a later date, quickly perform faceting against past search results, or efficiently rebuild and update the frozen collection. Additionally, the architecture is envisioned to manage "conversation collections" (such as email threading) and enable rapid "entity identification and location". This entity identification capability provides the system with the ability to quickly identify when a document contains a specific entity without requiring a complex search, as well as pinpointing the precise location of that entity in the content.

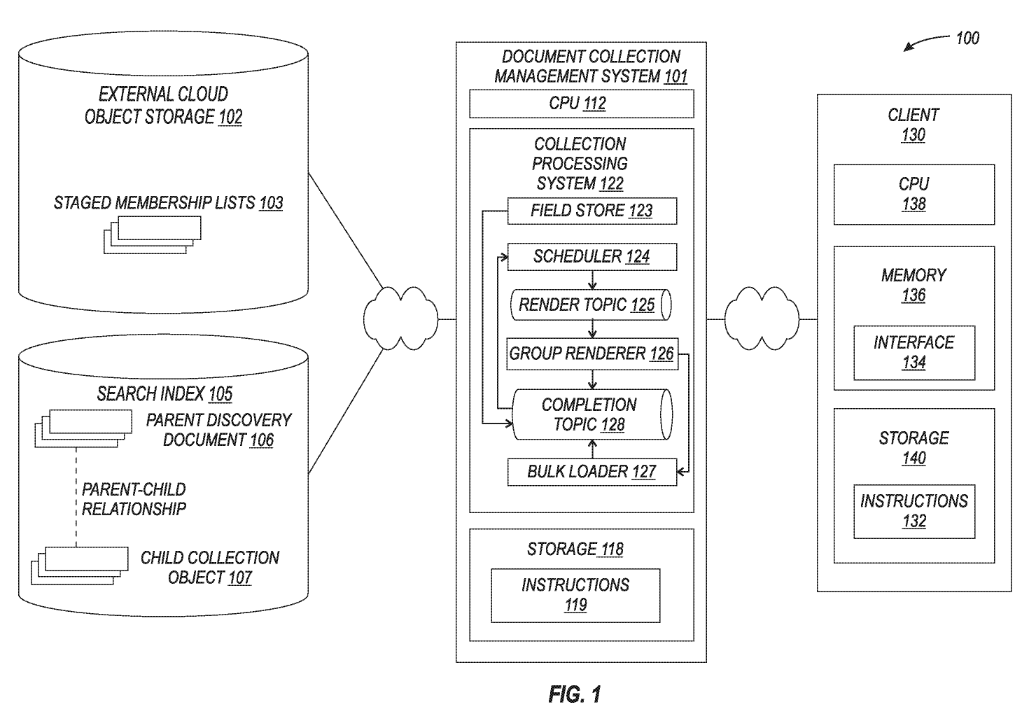

Looking now at FIG. 1, a block diagram of one embodiment of an architecture for managing arbitrary document collections is depicted. The document collection management system 101 is part of computing environment 100 including an external cloud object storage 102, a search index 105, document collection management system 101, and one or more client computers 130. External cloud object storage 102 may comprise a secure cloud-based staging service (such as Amazon S3) adapted to transactionally save large data structures. For example, external cloud object storage 102 may store one or more staged membership lists 103, which comprise lists of document IDs corresponding to massive groupings of electronic documents.

Search index 105 may comprise a file server, database system, or search engine mechanism remotely or locally accessible by document collection management system 101. According to an embodiment, search index 105 may be an Elasticsearch database or similar platform adapted to maintain decoupled object relationships. Search index 105 may store a plurality of parent discovery document 106 objects, representing the metadata for a specific file or item of electronic information. Search index 105 may further store a plurality of child collection object 107 records. Rather than embedding group membership metadata within the parent discovery document 106, collection membership is extracted into a distinct child collection object 107. Search index 105 maintains a parent-child relationship 108 linking the child collection object 107 to the parent discovery document 106.

In the depicted embodiment, document collection management system 101 may include one or more physical or virtual servers utilizing a central processing unit CPU 112 connected to a memory and a data store storage 118. CPU 112 may represent a single processor, multiple processors, or a processor with multiple processing cores. Storage 118 may include a volatile or non-volatile non-transitory storage medium such as RAM, hard disk drives, flash memory devices, or optical media. Document collection management system 101 may be connected to external cloud object storage 102, search index 105, and client computer 130 via a data communications network such as the Internet, a local area network (LAN), a wide area network (WAN), a cellular network, or some other network or combination of networks.

Storage 118 stores computer executable instructions 119, which can represent one or more multiple programs or operating system instructions. In one embodiment, instructions 119 are executable to provide a collection processing system 122. Collection processing system 122 may be implemented on the same computing systems or can be distributed across multiple computing systems, platforms, or virtual servers. Collection processing system 122 comprises several specialized microservices and message queues designed to execute asynchronous background indexing without disrupting active search operations. These components include a field store 123, a scheduler 124, a render topic 125, a group renderer 126, a bulk loader 127, and a completion topic 128.

To bypass standard payload limitations and prevent system lockups when grouping millions of documents, field store 123 serves as a system of record that saves a collection configuration pointing to the staged membership lists 103 stored in external cloud object storage 102. Field store 123 emits a completion event into completion topic 128, which acts as an asynchronous message queue. Scheduler 124 receives the signal from completion topic 128 and queues a rendering event by passing a message into render topic 125. Group renderer 126 receives the message from render topic 125, pulls the staged membership lists 103 from external cloud object storage 102, and computes the deltas or differences. Group renderer 126 then transmits the necessary updates to bulk loader 127 to be indexed into search index 105, and simultaneously emits a final completion signal back into completion topic 128.

Client computer 130 may include components similar to those of the server of document collection management system 101, such as CPU 138 and storage 140. Additionally, client computer 130 may include executable instructions 132 to provide user interface 134 via memory 136. User interface 134 allows a user to interact with document collection management system 101 to define new document groupings, review search term reports, and initiate background collection updates over the network.

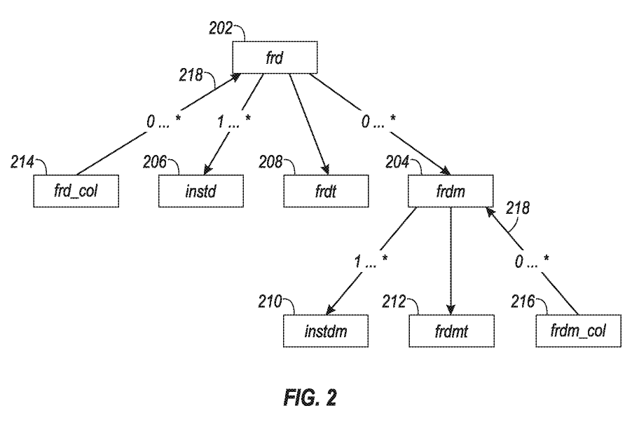

Turning now to FIG. 2, a block diagram illustrating an exemplary decoupled domain model for organizing discovery documents and their collection memberships within a search index is depicted. In traditional document management systems, the data defining a collection (or group) is embedded directly within the metadata of the document itself. In contrast, the domain model of FIG. 2 solves prior art performance bottlenecks by extracting the collection membership data into entirely separate, lightweight objects.

As shown in FIG. 2, the model comprises primary discovery documents, represented by a root discovery document node (frd) 202 and a member discovery document node (frdm) 204. The root discovery document 202 serves as the head of a document family, such as a primary email. The member discovery document 204 represents a child or subsidiary document connected to the root, such as an attachment to that primary email.

To improve overall search performance and prevent the primary discovery documents from becoming bloated, the model utilizes supporting contextual nodes. For example, an instance document node (instd) 206 represents the actual ingested source file (the "true source") from which the metadata of the discovery document 202 is derived. Because a database might ingest multiple identical copies of the exact same file (e.g., the same email existing in two different custodians' inboxes), the model can utilize a single root discovery document 202 to represent the shared metadata, while linking it to multiple instance document nodes 206. Similarly, a text content node (frdt) 208 acts as a text BLOB that strictly holds the written textual content of the document. By keeping the massive text BLOB separated from the core metadata of the root discovery document 202, the system avoids rewriting heavy text files whenever basic metadata changes. The member discovery document 204 similarly links to its own contextual instance document (instdm) 210 and text content (frdmt) 212.

One novelty of the decoupled architecture is illustrated by the child collection objects, represented by collection object (frd_col) 214 and member collection object (frdm_col) 216. Each of these collection objects 214, 216 is extracted from its respective parent document and stored as an individual, distinct child document within the search index (e.g., Elasticsearch). Each individual collection object 214 represents a single collection or group that the underlying discovery document is a member of.

In some embodiments, the relationship between the collection objects and the discovery documents is defined by a unidirectional edge 218. As depicted, the collection object 214 points to the root discovery document 202. In this embodiment of the decoupled architecture, the root discovery document 202 itself remains completely ignorant of the groups it is attached to. Because the main discovery document possesses no knowledge of its collections, the document collection management system can freely add a document to a new group (by writing a new collection object 214) or remove a document from a group (by deleting an existing collection object 214) without ever touching, locking, or rewriting the massive root discovery document 202. By completely eliminating the need to rewrite parent document metadata or heavy text nodes during group updates, the system avoids substantial input/output (I/O) bottlenecks, database locking stalls, and the write-amplification penalties that conventionally crash systems during massive bulk update operations.

Furthermore, the domain model is infinitely scalable. As indicated by the multiplicity notations (e.g., "0...*", "1...*", etc.), a given discovery document 202 can be a member of zero collections, or it can be a member of an infinite number of collections. If a document is added to thirty separate review stages or search term reports, the system simply generates thirty distinct collection objects 214 pointing to the parent document. Finally, membership within this model is highly granular and completely independent. The member discovery document 204 (the attachment) is not automatically placed in the same collection as its root discovery document 202 (the parent email). Instead, the member discovery document 204 maintains its own distinct member collection objects 216, allowing a user to route attachments and parent emails to entirely different workflow stages or analytical intersections if desired. Importantly, configuring the data structures as independent collection objects with unidirectional pointers improves the underlying functionality of the database by enabling hierarchical, Venn-diagram style analytical set operations to be executed natively within the single search index. This specialized data architecture overcomes the inherent synchronization bottlenecks of conventional polyglot architectures, allowing both traditional text search and complex analytical set operations to be performed highly efficiently within a single search engine.

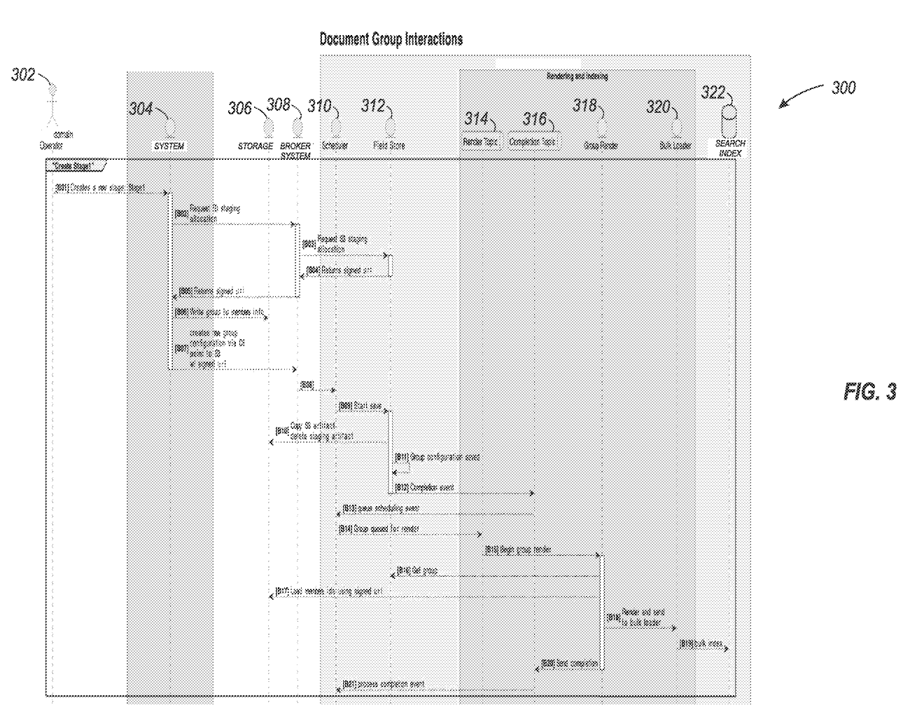

Turning now to FIG. 3, a sequence diagram illustrating an exemplary asynchronous background process 300 for creating a new document collection is depicted. The process 300 outlines the communication between various hardware and software components to securely stage and index a massive document grouping (e.g., adding millions of documents to a new review stage) without locking the underlying discovery documents or disrupting active search operations. The computing environment includes a domain operator 302, an originating system 304, an external storage 306, a broker system 308, a scheduler 310, a field store 312, a render topic 314, a completion topic 316, a group renderer 318, a bulk loader 320, and a search index 322.

The asynchronous creation process 300 can generally be divided into two phases: a setup phase (steps [B01] through [B12]) where the massive group membership list is securely staged, and a render phase (steps [B13] through [B21]) where the collection objects are asynchronously generated and indexed.

The setup phase begins at step [B01] when the domain operator 302 creates a new stage or grouping, indicating a desire to group a large set of documents together. This request is received by the originating system 304. In many instances, external object storage (such as S3 storage) is utilized because a single document group or collection could contain millions of members. Attempting to transmit massive membership lists directly could exceed standard gRPC payload limits. Therefore, the system avoids sending the entire list of document IDs directly to the database. Instead, at step [B02], the originating system 304 requests a storage staging allocation from broker system 308. At step [B03], the broker system 308 requests the allocation from the field store 312, which generates and returns a signed URL at step [B04]. The signed URL is passed back to the originating system 304 at step [B05].

Utilizing the signed URL, the originating system 304 securely writes the group members information (the massive list of document IDs) directly to the external storage 306 at step [B06]. Executing this operation via the external object storage requires ATOMIC writes and reads, which provides the necessary transactional consistency for these massive updates. This ensures atomic writes and reads for transactional consistency. At step [B07], the originating system 304 initiates an API call to the broker system 308 to create the new group configuration, passing along the signed URL pointing to the staged membership list in storage 306. This request is passed to the field store 312 at step [B08]. At step [B09], the field store 312 starts the save operation. At step [B10], the field store 312 securely copies the storage staging artifact and deletes the temporary staging artifact from storage 306. At step [B11], the group configuration is successfully saved to the system of record. To conclude the setup phase, the field store 312 emits a completion event at step [B12] by placing a message onto the completion topic 316, which acts as an asynchronous message queue.

The render phase is triggered asynchronously by this completion event. At step [B13], the scheduler 310 processes the completion event from the completion topic 316 and queues a scheduling event. At step [B14], the scheduler 310 queues the group for rendering by placing a message onto the render topic 314 (another message queue). At step [B15], the group renderer 318 picks up the message from the render topic 314 to begin the group render. At step [B16], the group renderer 318 makes a call to the field store 312 to get the group configuration and the location of the membership list.

At step [B17], the group renderer 318 loads all of the member document IDs using the signed URL directly from the external storage 306. At step [B18], the group renderer 318 generates the individual collection objects (as described in FIG. 2) and sends this data to the bulk loader 320. At step [B19], the bulk loader 320 executes a bulk index operation, writing the lightweight collection objects into the search index 322. Because this operation is loosely coupled and handled by background microservices, it avoids disrupting normal search experiences for active users querying the database. Once the indexing is complete, the group renderer 318 sends a final completion event at step [B20] to the completion topic 316. Finally, at step [B21], the scheduler 310 processes the final completion event, acknowledging internally that the entire asynchronous transaction has successfully finished.

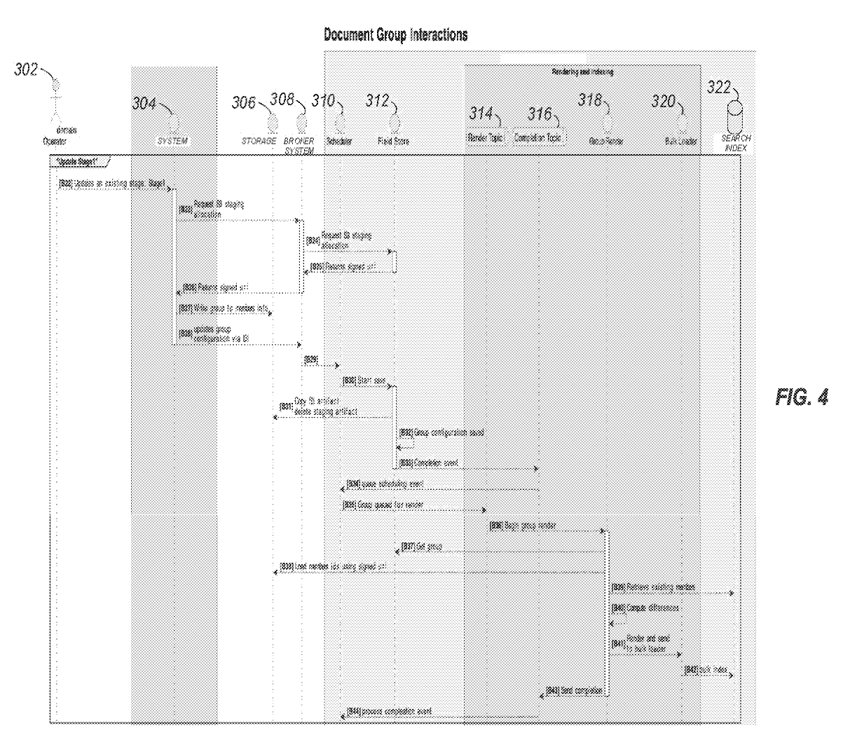

Turning now to FIG. 4, a sequence diagram illustrating an exemplary asynchronous background process for updating an existing document collection is depicted. This process outlines how the system handles changes to an existing group, such as adding or removing documents from an active litigation hold or a review stage, without requiring a full replacement of the entire group. The computing environment utilizes the same components introduced in FIG. 3, including a domain operator 302, an originating system 304, an external storage 306, a broker system 308, a scheduler 310, a field store 312, a render topic 314, a completion topic 316, a group renderer 318, a bulk loader 320, and a search index 322.

Any time a change is made to an existing collection, the update process is triggered. Similar to the creation process, the update process begins with a setup phase to safely stage the updated membership list. At step [B22], the domain operator 302 updates an existing stage or grouping, which is received by the originating system 304. At step [B23], the originating system 304 requests a storage staging allocation from the broker system 308. At step [B24], the broker system 308 requests the storage staging allocation from the field store 312. The field store 312 generates and returns a signed URL at step [B25], which the broker system 308 passes back to the originating system 304 at step [B26].

Using the signed URL, the originating system 304 securely writes the newly updated group members information to the external storage 306 at step [B27]. At step [B28], the originating system 304 initiates an API call to the broker system 308 to update the group configuration, which is then passed to the field store 312 at step [B29]. At step [B30], the field store 312 begins the save operation. To ensure consistency, the field store 312 copies the storage artifact and deletes the temporary staging artifact at step [B31]. At step [B32], the updated group configuration is saved, and at step [B33], the field store 312 emits a completion event into the completion topic 316.

The subsequent render phase introduces a critical efficiency optimization specifically designed for updates. At step [B34], the scheduler 310 processes the completion event and queues a scheduling event. At step [B35], the scheduler 310 queues the updated group for rendering by placing a message onto the render topic 314. At step [B36], the group renderer 318 picks up the message to begin the render process. At step [B37], the group renderer 318 gets the group configuration from the field store 312, and at step [B38], it loads the newly saved member IDs using the signed URL directly from the external storage 306.

To avoid a computationally expensive complete replacement of all group records, the system only processes the differences. At step [B39], the group renderer 318 queries the search index 322 to retrieve the existing members currently associated with the collection. At step [B40], the group renderer 318 computes the differences (deltas) between the newly saved list of member IDs and the existing list of member IDs in the search index 322. By identifying this minimal set of changes, the system determines exactly which specific collection objects need to be inserted (for new documents added to the group) and which specific collection objects need to be deleted (for documents removed from the group).

At step [B41], the group renderer 318 renders and sends only this minimal set of differences to the bulk loader 320. At step [B42], the bulk loader 320 executes a bulk index operation, writing only the necessary inserts and deletes to the search index 322. Once the bulk update of the deltas is complete, the group renderer 318 sends a final completion event at step [B43] to the completion topic 316. Finally, at step [B44], the scheduler 310 processes the final completion event, acknowledging internally that the entire asynchronous update transaction has successfully finished.

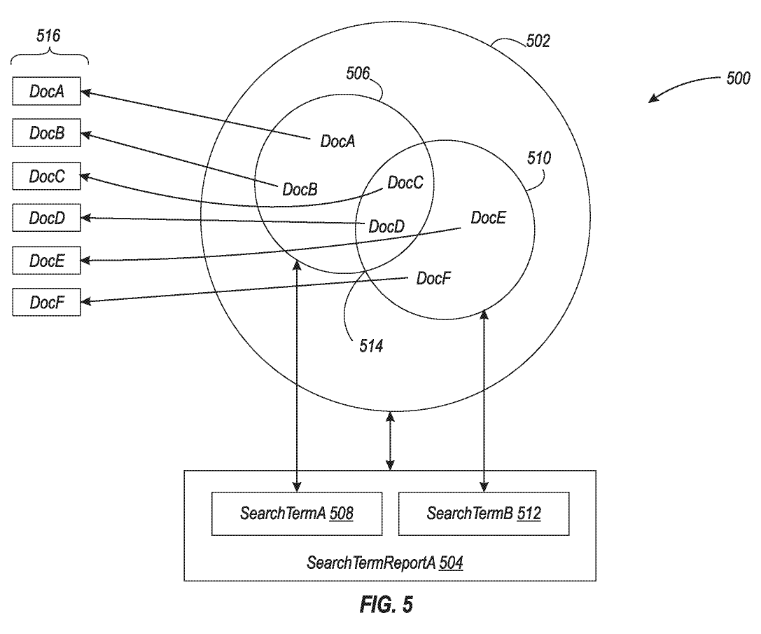

Turning now to FIG. 5, a conceptual diagram 500 illustrating the system's ability to execute complex hierarchical analysis and set operations within a single search index is depicted. As previously described, extracting collection membership into distinct, lightweight objects enables rapid, asynchronous updating. However, as illustrated in FIG. 5, this decoupled architecture provides the additional substantial benefit of allowing the search engine to natively map complex hierarchical relationships and execute Venn diagram-style set operations.

Conventionally, executing both traditional text searches and complex analytical slicing and dicing of massive document collections requires a "polyglot" architecture. Polyglot systems attempt to operate two separate database engines concurrently, one optimized for standard search and one optimized for analytical set relationships, and struggle to maintain synchronization between them, resulting in notoriously unperformant systems. The architecture of the present disclosure solves this polyglot problem by natively supporting multi-level hierarchies and rapid set math within the primary search index.

FIG. 5 illustrates an example of this hierarchical set math using a search term report. The diagram 500 includes an outer superset collection 502, which represents the overarching parent collection, such as Search Term Report A 504. Nested within the superset collection 502 are multiple child collections, depicted here as Collection A 506 (corresponding to the results for Search Term A 508) and Collection B 510 (corresponding to the results for Search Term B 512).

Because the collection objects are decoupled from the massive underlying discovery documents, the system can rapidly map specific documents to various intersecting areas of the hierarchy. As shown in the exemplary Venn diagram mapping, a first subset of documents 516, Doc A and Doc B, are located strictly within Collection A 506. A second subset of documents 516, Doc E and Doc F, are located strictly within Collection B 510. Finally, Doc C and Doc D are located within an intersection 514, meaning they are members of both Collection A 506 and Collection B 510.

By structuring the data in this manner, the system can easily perform logical set operations (e.g., intersections, unions, and differences) directly within the search index. A user can efficiently query the system to return the union of all collections (e.g., all documents within the superset collection 502). Alternatively, a user can execute granular exclusion queries to determine precisely which documents are in one collection but not another (e.g., returning Doc A and Doc B by querying for documents in Collection A 506 excluding those in Collection B 510). Consequently, the decoupled architecture allows traditional search operations and advanced, hierarchical analytical operations to be executed highly efficiently within a single search engine.

As previously described, the collection objects are decoupled from the main discovery documents and stored as distinct child documents within the search index. In certain embodiments, such as an implementation utilizing an Elasticsearch database, specific mapping fields are utilized within these child objects to manage the hierarchical data efficiently and accurately. To optimize indexing performance, the mapping in the search index can use a parent-child join mechanism, enabling the indexing of group memberships entirely outside of the normal discovery document traffic flow.

For example, a collection object (e.g., an frd_collection child document) may utilize strict dynamic mapping and contain specific properties, including an id_collection field, a type_names field, a hierarchy_paths field, and a _cids_leafs field. The id_collection field stores the unique numerical identifier for the specific collection. The type_names field stores a keyword or string identifying the particular type of the collection, such as a nested folder, a search term report, or a review stage.

To maintain the multi-level tree structure natively within the search engine (as described with reference to FIG. 5) without modifying the parent discovery document, the collection object utilizes the hierarchy_paths field. This field stores the full string path of the collection's ancestry, formatted to include each node up the hierarchy path (e.g., grandparent_id/parent_id/collection_id).

Furthermore, the _cids_leafs field stores an array of collection IDs representing all descendant leaf nodes for which the underlying discovery document is a direct member. This specific internal field structure provides significant advantages for executing aggregation queries. In conventional indexing schemes, rolling up document counts from multiple overlapping child collections to a parent collection often results in inaccurate double-counting, because the parent ID is reported multiple times for each child. By configuring the system to generate one distinct, independent search index entry per collection, explicitly tracking the descendant leaf nodes in this field ensures accurate aggregation counts at a parent level (e.g., a superset collection). Consequently, this tracking mechanism prevents the database from double-counting a single document that happens to be a member of multiple overlapping child collections.

To ensure accurate aggregation and system stability during these operations, the document collection management system may implement specific concurrency control and hierarchy tracking strategies. For concurrency control, the system may utilize optimistic concurrency, which executes more quickly and is natively available in many search engines, or group locking, which involves more computational overhead. Furthermore, for hierarchy tracking, the system utilizes a usage list rather than a usage count. Search indexes generally lack the concept of strict transactions; therefore, if a failure occurs while updating a standard usage count, it is impossible to tell whether a specific parent node was accurately incremented or decremented. By adding a field on intermediate nodes that acts as a usage list (explicitly tracking the list of all leaf collections for which a document is actually a member), the system can safely amend the list as needed, as amending a usage list is an idempotent operation.

Finally, a search system or client application can efficiently query these specific data structures to determine document grouping. To query for documents belonging to specific collections, the calling system can provide the collection ID and type, and execute a has_child query to test group membership against the separate collection objects, seamlessly connecting active user searches to the asynchronously updated collections.

In some embodiments, to optimize performance when managing large document collections as child documents, the computing system may employ specific shard count strategies. For example, keeping collections to one shard per node optimizes performance, while utilizing multiple shards per node (e.g., four shards for an extra-large data shape) may increase CPU and search thread usage, resulting in increased overall latency. Furthermore, executing queries against the collection objects utilizing a search index cache significantly reduces response times compared to uncached queries, enabling highly performant retrieval even with massive collections containing millions of descendant nodes.

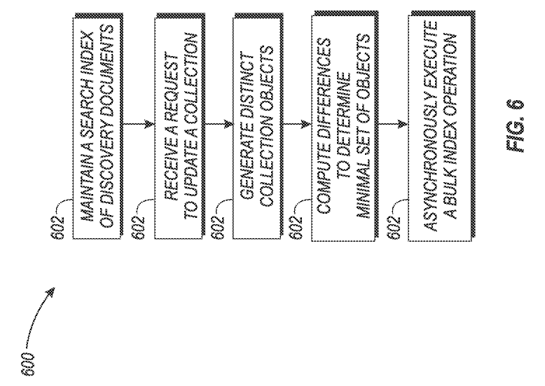

Turning now to FIG. 6, a flowchart illustrating an exemplary method 600 for managing document collections within a computing system is depicted. Method 600 broadly outlines the decoupled architecture utilized to update massive collections of electronic documents efficiently and asynchronously, as described in detail above.

The method begins at step 602, where the computing system maintains a search index storing a plurality of discovery documents. At step 604, the system receives a request to update a target document collection with a new list of member document identifiers. This request may originate from a user action, such as adding or removing documents from a workflow review stage or executing a search term report.

At step 606, the system generates a plurality of distinct collection objects corresponding to the new list of member document identifiers. In some embodiments, to prevent the parent documents from becoming bloated with metadata, each generated distinct collection object points to its corresponding discovery document using a unidirectional relationship. By structuring the pointers in this manner, the parent discovery document remains entirely ignorant of its collection memberships.

At step 608, the system computes a difference (or delta) between the new list of member document identifiers and an existing list of member document identifiers currently represented in the search index. By identifying only the differences between the two states, the system determines the absolute minimal set of new collection objects to insert and the minimal set of existing collection objects to delete.

Finally, at step 610, the system asynchronously executes a bulk index operation to apply the minimal set of collection objects to insert and the minimal set of collection objects to delete to the search index. Because the collection objects are distinctly separated from the primary document data, this bulk index operation can be executed without locking, rewriting, or otherwise modifying the massive plurality of discovery documents, thereby entirely decoupling the lifecycle of the document collections from the lifecycle of the underlying discovery documents.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited to only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout, the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method for managing document collections within a computing system, the method comprising:
maintaining a search index storing a plurality of discovery documents;
receiving a request to update a target document collection with a new list of member document identifiers;
generating a plurality of distinct collection objects corresponding to the new list, wherein each distinct collection object points to its corresponding discovery document in a unidirectional relationship;
computing a difference between the new list of member document identifiers and an existing list of member document identifiers in the search index to determine a minimal set of collection objects to insert and a minimal set of collection objects to delete; and
asynchronously executing a bulk index operation to apply the minimal set of collection objects to insert and the minimal set of collection objects to delete to the search index without locking or rewriting the plurality of discovery documents, thereby decoupling a lifecycle of the document collection from a lifecycle of the discovery documents.

2. The method of claim 1, wherein at least one distinct collection object comprises a hierarchy path field storing a full string path of the specific document collection's ancestry, thereby natively maintaining a multi-level tree structure within the search index.

3. The method of claim 1, wherein at least one distinct collection object comprises a leaf field storing an array of collection identifiers representing all descendant leaf nodes for which the corresponding discovery document is a direct member, and wherein the method further comprises executing an aggregation query using the leaf field to accurately count unique documents without double-counting overlapping child collections.

4. The method of claim 1, wherein receiving the request to update the target document collection comprises:
generating a signed uniform resource locator (URL) for an external storage;
writing the new list of member document identifiers to the external storage using the signed URL to bypass payload limits; and
passing the signed URL to a group rendering service to asynchronously retrieve the new list from the external storage prior to computing the difference.

5. The method of claim 1, wherein the plurality of discovery documents comprises a root discovery document representing a parent file and a member discovery document representing an attachment to the parent file, and wherein the distinct collection objects independently assign the root discovery document and the member discovery document to completely different document collections.

6. The method of claim 1, wherein written textual content associated with each discovery document is stored in a separate text content node within the search index, thereby preventing the rewriting of massive textual content when the distinct collection objects are updated.

7. The method of claim 1, further comprising executing a logical set operation query against the search index, the logical set operation query determining an intersection or an exclusion between a first document collection and a second document collection by analyzing the distinct collection objects without querying the plurality of discovery documents.

8. A system for managing document collections, the system comprising:
one or more processors; and
a memory storing instructions that, when executed by the one or more processors, cause the system to:
maintain a search index storing a plurality of discovery documents;
receive a request to update a target document collection with a new list of member document identifiers;
generate a plurality of distinct collection objects corresponding to the new list, wherein each distinct collection object points to its corresponding discovery document in a unidirectional relationship;
compute a difference between the new list of member document identifiers and an existing list of member document identifiers in the search index to determine a minimal set of collection objects to insert and a minimal set of collection objects to delete; and
asynchronously execute a bulk index operation to apply the minimal set of collection objects to insert and the minimal set of collection objects to delete to the search index without locking or rewriting the plurality of discovery documents, thereby decoupling a lifecycle of the document collection from a lifecycle of the discovery documents.

9. The system of claim 8, wherein at least one distinct collection object comprises a hierarchy path field storing a full string path of the specific document collection's ancestry, thereby natively maintaining a multi-level tree structure within the search index.

10. The system of claim 8, wherein at least one distinct collection object comprises a leaf field storing an array of collection identifiers representing all descendant leaf nodes for which the corresponding discovery document is a direct member, and wherein the instructions further cause the system to execute an aggregation query using the leaf field to accurately count unique documents without double-counting overlapping child collections.

11. The system of claim 8, wherein the instructions to receive the request to update the target document collection further cause the system to:
generate a signed uniform resource locator (URL) for an external storage;
write the new list of member document identifiers to the external storage using the signed URL; and
pass the signed URL to a group rendering service to asynchronously retrieve the new list from the external storage prior to computing the difference.

12. The system of claim 8, wherein the plurality of discovery documents comprises a root discovery document representing a parent file and a member discovery document representing an attachment to the parent file, and wherein the distinct collection objects independently assign the root discovery document and the member discovery document to completely different document collections.

13. The system of claim 8, wherein written textual content associated with each discovery document is stored in a separate text content node within the search index, thereby preventing the rewriting of textual content when the distinct collection objects are updated.

14. The system of claim 8, wherein the instructions further cause the system to execute a logical set operation query against the search index, the logical set operation query determining an intersection or an exclusion between a first document collection and a second document collection by analyzing the distinct collection objects without querying the plurality of discovery documents.

15. A non-transitory computer-readable storage medium storing instructions for managing document collections, the instructions executable by one or more processors of a computing system to cause the computing system to:
maintain a search index storing a plurality of discovery documents;
receive a request to update a target document collection with a new list of member document identifiers;
generate a plurality of distinct collection objects corresponding to the new list, wherein each distinct collection object points to its corresponding discovery document in a unidirectional relationship;
compute a difference between the new list of member document identifiers and an existing list of member document identifiers in the search index to determine a minimal set of collection objects to insert and a minimal set of collection objects to delete; and
asynchronously execute a bulk index operation to apply the minimal set of collection objects to insert and the minimal set of collection objects to delete to the search index without locking or rewriting the plurality of discovery documents, thereby decoupling a lifecycle of the document collection from a lifecycle of the discovery documents.

16. The non-transitory computer-readable storage medium of claim 15, wherein at least one distinct collection object comprises a hierarchy path field storing a full string path of the specific document collection's ancestry, thereby natively maintaining a multi-level tree structure within the search index.

17. The non-transitory computer-readable storage medium of claim 15, wherein at least one distinct collection object comprises a leaf field storing an array of collection identifiers representing all descendant leaf nodes for which the corresponding discovery document is a direct member, and wherein the instructions further cause the computing system to execute an aggregation query using the leaf field to accurately count unique documents without double-counting overlapping child collections.

18. The non-transitory computer-readable storage medium of claim 15, wherein the instructions to receive the request to update the target document collection further cause the computing system to:
generate a signed uniform resource locator (URL) for an external storage;
write the new list of member document identifiers to the external storage using the signed URL; and
pass the signed URL to a group rendering service to asynchronously retrieve the new list from the external storage prior to computing the difference.

19. The non-transitory computer-readable storage medium of claim 15, wherein the plurality of discovery documents comprises a root discovery document representing a parent file and a member discovery document representing an attachment to the parent file, and wherein the distinct collection objects independently assign the root discovery document and the member discovery document to completely different document collections.

20. The non-transitory computer-readable storage medium of claim 15, wherein the instructions further cause the computing system to execute a logical set operation query against the search index, the logical set operation query determining an intersection or an exclusion between a first document collection and a second document collection by analyzing the distinct collection objects without querying the plurality of discovery documents.
